(19) United States
(12) Patent Application Publication
(10) Pub. No.: US 2023/0415918 A1
(43) Pub. Date: Dec. 28, 2023

(54) AIRCRAFT TOWING SYSTEM AND METHOD FOR TOWING AN AIRCRAFT

(71) Applicant: TLD EUROPE, Reffannes (FR)

(72) Inventors: Laurent DECOUX, Sorigny (FR); Romain HUDELOT, Sorigny (FR)

(21) Appl. No.: 18/338,402

(22) Filed: Jun. 21, 2023

(30) Foreign Application Priority Data
Jun. 22, 2022 (EP) 22305907.2

(51) Int. Cl. B64F 1/22

(52) U.S. Cl. CPC B64F 1/228; B64F 1/227

(57) ABSTRACT

The application relates to an aircraft towing system for an airport (1) having at least one towing zone (10) for said aircraft (15). The towing system includes: at least one tow-tractor (21) configured to be operated remotely by means of a wireless connection; a control device intended to be connected to the tow-tractor (21) using the wireless connection and able to control said tow-tractor; and a first sensor (23) intended to equip the towing zone (10) and suitable for supplying information about elements (11A, 11B, 11C) likely to be encountered by the aircraft (15) and/or the tow-tractor (21). The control device is further configured to collect the information supplied by the at least one first sensor (23) and exploit it in controlling the tow-tractor (21) to tow the aircraft (15).

### TECHNICAL FIELD

The invention relates to the field of aircraft tow-tractors or tugs and that of the control thereof.

The present invention more particularly relates to a system for towing aircraft, to an airport equipped with such a system and to a method for towing aircraft.

### PRIOR ART

Because aircraft do not generally have the ability to move backward and exhibit reduced maneuverability, it is known practice to resort to aircraft tow-tractors or tugs notably for moving the aircraft around from where they are parked (on the hard standing or apron) to the start of the taxiway.

Such aircraft towing or, more specifically, push-back, operations are relatively complicated to perform and require, in addition to the tow-tractor driver, and because the driver has limited visibility regarding the immediate surroundings of the aircraft, one or more ramp agents to guide the driver during the manoeuvre.

In order to optimize these push-back operations and to limit the number of personnel on the apron, it would be beneficial to at least partially automate the control of the tow-tractors. Nevertheless, given the complexity of the push-back manoeuvre and the significant need for this to be safe, there is not currently any towing system in existence that can be at least partially automated and able to dispense with an in-situ operator.

### SUMMARY OF THE INVENTION

The invention thus seeks to overcome this disadvantage and therefore relates to the supply of a towing system that can be implemented remotely away from the towing zone in which the towing of the aircraft is to take place, while at the same time maintaining a high level of safety as it is the case for the current towing systems based on a driver and at least one ramp agent guiding the driver.

To this end, the invention relates to an aircraft towing system for an airport having at least one towing zone in which an aircraft is likely to be towed, the towing system comprising:
at least one tow-tractor configured to be operated remotely by means of a wireless connection and suitable for towing the aircraft,
a control device intended to be connected to the tow-tractor using the wireless connection and able to control said tow-tractor,
at least one first sensor intended to be positioned in the towing zone, this or these first sensors being independent of the tow-tractor and being able to supply information about elements likely to be encountered by the aircraft and/or the tow-tractor during the operation of towing the aircraft using the tow-tractor,
the control device being further configured to collect the information supplied by the at least one first sensor and exploit it in controlling the tow-tractor to tow the aircraft.

With such an aircraft towing system, the presence of ramp agents to guide the tow-tractor during the push-back manoeuvre becomes unnecessary. Specifically, thanks to the at least one first sensor, the control device is able to account for any obstacles (or elements) that might be present during the towing without the intervention of any ramp agent. This results in a reduction in the risk to said agents during the push-back manoeuvres.

The information about the elements likely to be encountered by the aircraft and/or the tow-tractor during the operation of towing the aircraft using the tow-tractor may just as well be one or more images of these elements, the first sensor or sensors then each being a sensor of the imager type, as be an identification of a location of these elements with respect to a reference, such as a predefined reference of the towing zone or one out of either the tow-tractor or the aircraft, the first sensor or sensors then each being a detection device, for example of the telemeter type, able to detect the elements likely to be encountered by the aircraft and/or the tow-tractor during the operation of towing the aircraft using the tow-tractor.

It must be understood hereinabove and in the remainder of this document that an image means any type of digital file incorporating one or more two-dimensional or three-dimensional images, it being appreciated that a video or a video stream incorporates a plurality of images and that an image obtained by LIDAR (the acronym for light detection and ranging) is a three-dimensional image.

It should be understood here and in the remainder of the document that exploiting the information in controlling the tow-tractor to tow the aircraft means using said information to identify said elements either by the control device itself or by an operator operating said control device, said device then being able to prevent and/or adapt this or these items of information in order to present it or them to the operator.

It will be noted that “able to be operated remotely” here and in the rest of this document means that the tow-tractor can be controlled by means of the wireless connection, and from a distance greater than 5 m, preferably 50 m, or even than 500 m or even from 2 km. It will thus be noted that, according to a first possibility offered by the invention, the tow-tractor may be able to be controlled from an airport building, such as an airport control tower, or else from a very long distance away. Thus, according to a second possibility offered by the invention, the tow-tractor can be controlled from a very long range connection, the control device being able to be positioned in a data centre using a dedicated server, or else in a specialist company away from the airport, or even from an operator's home in the context of remote working.

The at least one first sensor may be a sensor able to supply an image of at least part of the towing zone, said at least one first sensor preferably being selected from: an optical camera working in the visible or in the infrared and an imager of the LIDAR type.

In this way, it is possible to obtain visual information about the elements likely to be encountered by the aircraft and/or the tow-tractor during the control of the latter so as to limit the risks of collisions during towing.

The control device may have a human/machine interface so as to allow said tow-tractor to be controlled by an operator from said control device

The control device may comprise a display system able to supply a display including, at least in part, the image or images supplied by the at least one first sensor.

Such a control device makes it possible to supply the visual information regarding said elements to any operator that might be tasked with controlling the tow-tractor from the control device. Such visual information facilitates the control task of the operator who is able to see the risks associated with the towing of the aircraft.

The aircraft towing system may comprise a plurality of first sensors intended to equip the towing zone, the control device being configured to combine the images supplied by the first sensors in order to supply a display of the elements likely to be encountered by the aircraft and/or the tow-tractor on the towing zone during the towing operation.

Such a combination of images makes it possible to supply an overall view of the situation of the aircraft and/or of the tow-tractor, thereby limiting the risks associated with these various elements during the towing operation.

The or at least one first sensor may be intended to be installed fixedly in the towing zone.

In this way, it is possible to arrange the first sensor or sensors at strategic locations in the towing zone.

The, or at least one, first sensor is fitted to a mobile vehicle, said mobile vehicle preferably being selected from an airport vehicle and a dedicated, advantageously autonomous, mobile vehicle.

Thus, aside from the fact that such a possibility makes it possible to limit the need for modifications to the towing zone, it also provides the benefit of a significant number of viewpoints, since each airport vehicle is capable of being equipped. It will also be noted that, in instances in which the or at least one first sensor is fitted to a dedicated autonomous vehicle, it is possible for said dedicated autonomous vehicle or vehicles to follow the aircraft and the tow-tractor as closely as possible during towing, thereby offering full coverage of the zone around the aircraft during the entirety of the towing operation. Such autonomous vehicles may effectively become an immaterial barrier defining a zone in which any element likely to be encountered by the aircraft and/or the tow-tractor can be detected.

The or each tow-tractor may comprise at least one second sensor able to detect an obstacle lying in its path, the control device being further configured to collect the information supplied by the at least one second sensor and exploit it in controlling the tow-tractor to tow the aircraft.

Such equipment contributes to the safety of the towing operation and additionally makes it possible for the operation of bringing the tow-tractor into the towing zone to become safer even when the entire airport is not necessarily equipped with first sensors.

The control device may be able to control the tow-tractor autonomously on the basis of at least the information supplied by the first sensor or sensors.

The invention further relates to an airport equipped with an aircraft towing system according to the invention.

Such an airport enjoys the advantages associated with the towing system with which it is equipped.

The invention further relates to a method for installing a system for towing aircraft according to the invention in an airport, the airport having at least one towing zone in which an aircraft is likely to be towed, the installation method comprising the following steps:
supplying at least one tow-tractor configured to be operated remotely by means of a wireless connection and suitable for towing the aircraft,
installing at least one control device connected to the tow-tractor using the wireless connection and able to control said tow-tractor, and
arranging, in the towing zone, at least one first sensor able to supply information about elements likely to be encountered by the aircraft and/or the tow-tractor during the operation of towing the aircraft using the tow-tractor, the or each first sensor being independent of the tow-tractor,
the control device being further configured to collect the information supplied by the at least one first sensor and exploit it in controlling the tow-tractor to tow the aircraft.

Such a method allows a towing system to be installed in an airport, thus allowing it to enjoy the advantages associated with this system.

Equipping the towing zone with at least one first sensor may be achieved by deploying at least one mobile vehicle having said at least one first sensor, the mobile vehicle preferably being selected from an airport vehicle and a dedicated autonomous mobile vehicle.

Such mobile vehicles offer the advantage of making it easier to install the towing system according to the invention because there is no need to install the first sensors fixedly. The method is thereby facilitated.

The invention further relates to a method for towing aircraft comprising the following steps:
identifying the aircraft that is to be towed in a towing zone equipped with at least one first sensor able to supply information about elements likely to be encountered by the aircraft and/or a tow-tractor during an operation of towing the aircraft,
identifying a tow-tractor configured to be operated remotely by means of a wireless connection and suitable for towing the aircraft,
remotely controlling the tow-tractor identified for towing the aircraft from a control device connected to the tow-tractor using the wireless connection, the control device collecting the information supplied by the at least one first sensor and exploiting it or them in controlling the tow-tractor, the first sensor being arranged in the towing zone and being suitable for supplying information about elements likely to be encountered by the aircraft and/or the tow-tractor during the operation of towing the aircraft using the tow-tractor, the or each first sensor being independent of the tow-tractor.

With such a method it is possible, in a conforming manner, to tow the aircraft in complete safety because the information supplied by the first sensor or sensors is used in such a way as to limit the risks associated with the elements likely to be encountered by the aircraft and/or the tow-tractor.

### BRIEF DESCRIPTION OF THE DRAWINGS

The present invention will be better understood from reading the description of purely indicative and entirely nonlimiting exemplary embodiments, with reference to the attached drawings in which:

FIG. 1 illustrates a hardstanding equipped with first sensors of an aircraft towing system according to the invention;

FIG. 2 illustrates a control device for a towing system according to the invention, one of the screens of the control device showing the information originating from the first sensors with which the hardstanding is equipped;

FIG. 3 illustrates, on the left, a view of an image reconstructed from the images supplied by the first sensors of the hardstanding in the context of a pushback manoeuvre configuration illustrated, viewed from above, to the right of this same figure,

FIG. 4 illustrates a hardstanding according to a second embodiment in which the first sensors of the aircraft towing system are arranged on autonomous vehicles dedicated to monitoring the aircraft surroundings while it is being towed so as to define an immaterial barrier.

Parts in the various figures that are identical, similar or equivalent bear the same numerical references so as to make it easier to transition from one figure to another.

In order to make the figures easier to understand, the various parts depicted in the figures are not necessarily all drawn to the same scale.

The various possibilities (embodiments and variants) are to be understood as not being mutually exclusive and may be combined with one another.

### DETAILED DESCRIPTION OF PARTICULAR EMBODIMENTS

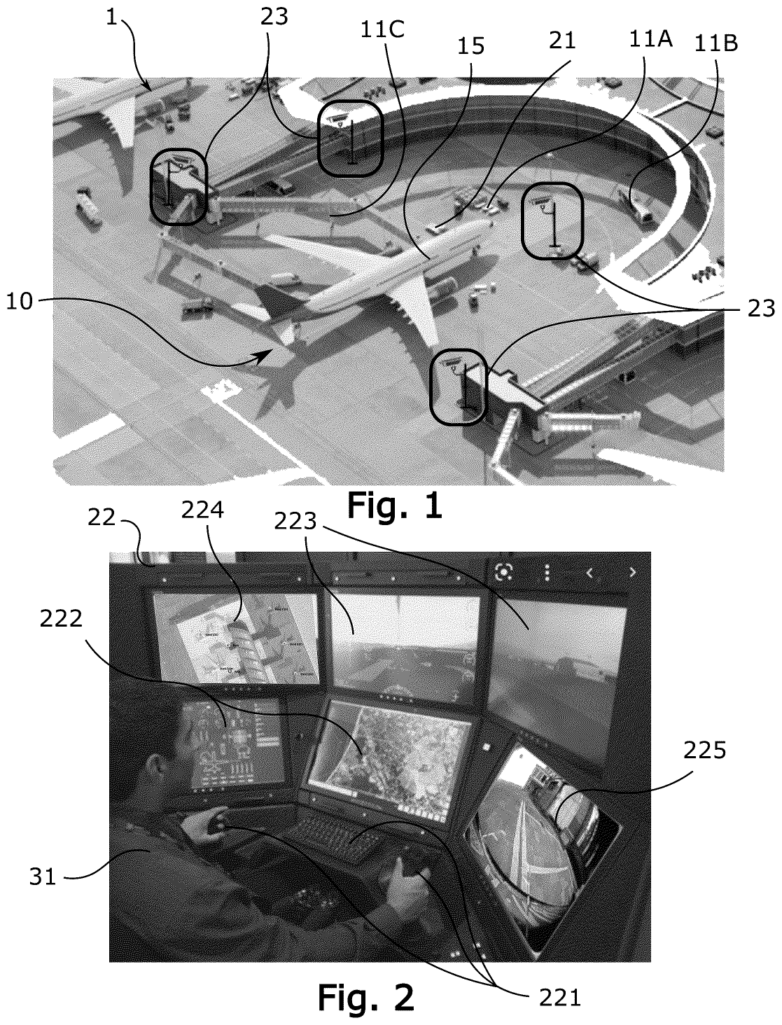

FIG. 1 depicts a hardstanding 10 of an airport 1 which is equipped with a towing system according to a first embodiment of the invention so as to allow an aircraft 15 to be towed by a tow-tractor 21 of said towing system.

It will be noted that such a towing operation generally involves aircraft pushback operations so that the aircraft can be towed from a hardstanding 10 to the start of a taxiway, not featured, although the present invention may be implemented during other types of towing operation without departing from the context of the invention. Thus, for example, it will be noted that the towing may be performed in a towing zone other than an aircraft hardstanding, such as in an aircraft storage or maintenance zone.

It will also be noted that the tow tractor or tractors according to the invention are advantageously tow-tractors that do not have towbars, generally known by the name of “towbarless tractors”. Specifically, using such tow-tractors, the aircraft can be coupled to the tow-tractor without the need for human intervention. Of course, while this possibility is particularly advantageous, the towing system may also be implemented using tow-tractors that employ a towbar, a ramp agent then being able to intervene solely to couple the towbar to the aircraft (uncoupling possibly being able to be automated).

A towing system according to the invention comprises:
the tow-tractor 21, said tow-tractor being configured to be operated remotely by means of a wireless connection and suitable for towing the aircraft 15,
a control device 22, illustrated in FIG. 2, connected to the tow-tractor 21 using the wireless connector and able to control said tow-tractor 21, and
four first sensors 23 with which the hardstanding 10 is equipped, the first sensors 23 being able to supply information about elements 11A, 11B, 11C likely to be encountered by the aircraft 15 and/or the tow-tractor 21 during the operation of towing the aircraft 15 using the tow-tractor 21.

It will be noted that while the first sensors 23 according to this first embodiment are installed fixedly, as shown in FIG. 1, on the hardstanding, by means of posts, it is also conceivable, as will be discussed in connection with FIG. 4, for the sensors 23 to be arranged with the ability to move around in the present hardstanding 10. Such a mobile arrangement may be obtained for example by installing this or these first sensors 23 on one or more airport vehicles, such as other tow-tractors 21, buses or even luggage handling tractors, or else on one or more dedicated autonomous moving vehicles 23A, as discussed later on in connection with FIG. 4.

According to the invention, the control device 22 is further configured to collect the information supplied by the at least one first sensor 23 and exploit it in controlling the tow-tractor 21 to tow the aircraft 15.

It will be noted that, in the context of an envisioned implementation of the invention, it can be that the control device 22 is not dedicated to a given tow-tractor 21 but may be designed to control other tow-tractors, the tow-tractor 21 controlled being selected according to its availability and its proximity to the aircraft, for example by means of aircraft fleet management software. In addition, in this embodiment, since the control device comprises, as illustrated in FIG. 2, a human/machine interface to allow an operator to control the tow-tractor 21, the airport may comprise several control devices 22 so as to allow several towing operations to be performed in parallel with one another.

The tow-tractor 21 has the usual configuration of a tow-tractor that can be used for towing an aircraft 15, notably so far as the power and the system for coupling to the aircraft landing gear are concerned. The tow-tractor 21 is preferably electrically powered and, in this option, carries on board batteries of sufficient capacity for it to be able to be operated for several hours. According to the invention, the tow-tractor 21 is configured to be operated remotely by means of a wireless connection. Such a wireless connection may be a radiofrequency connection using a standard wireless communications protocol such as a WIFI protocol or a mobile telephony protocol (GSM, GPRS, 3G, 4G or even 5G). Of course, to ensure the security of the communications between the tow-tractor 21 and the control device 22, the wireless connection is preferably encoded and may employ several redundant control loops simultaneously on the transmitter and receiver side, this being so as to avoid any risk of the tow-tractor 21 being hacked. As an alternative, the wireless connection may be based on a proprietary protocol which may or may not be based on a standard wireless communications protocol. Whatever the case, the wireless communications protocol is preferably chosen to have a low latency so as to allow commands to be actioned quickly.

The tow-tractor 21 may further be equipped with one or more second sensors, not illustrated, to make it easier to control them remotely. This or these second sensors are able to detect an obstacle lying in the path of the tow-tractor 21. Such second sensors may, according to the present embodiment, be on-board cameras, preferably operating in the wavelengths of the visible part of the spectrum. In alternative or in addition, the second sensor or sensors may also comprise one or more images of the LIDAR type or ultrasound detectors.

According to the present embodiment, the control device 22 is designed to allow the tow-tractor to be controlled by an operator 31 and therefore has a human/machine interface 221, 222, 223, 224, 225 comprising a control interface 221 and several screens 222, 223, 224, 225. The control interface 221 comprises two joysticks for controlling the movements of the tow-tractor 21 and a keypad for modifying the configuration of the control device and notably configuring the tow-tractor that is being controlled. So far as the screens 222, 223, 224, 225 are concerned, two screens 222 display information regarding the towing operation in progress, notably with information relating to the aircraft and a satellite map. Two further screens 223 provide a display originating from second sensors of the tow-tractor 21 so as to allow the operator 31 to obtain a view similar to that which said operator would have were they stationed at the controls of the tow-tractor 21. A fifth screen 224 allows the operator to access fleet management software, such as the XOPS™ software marketed by the RESONATE™ company, so as to identify the aircraft that are to be towed and the tow-tractors 21 available.

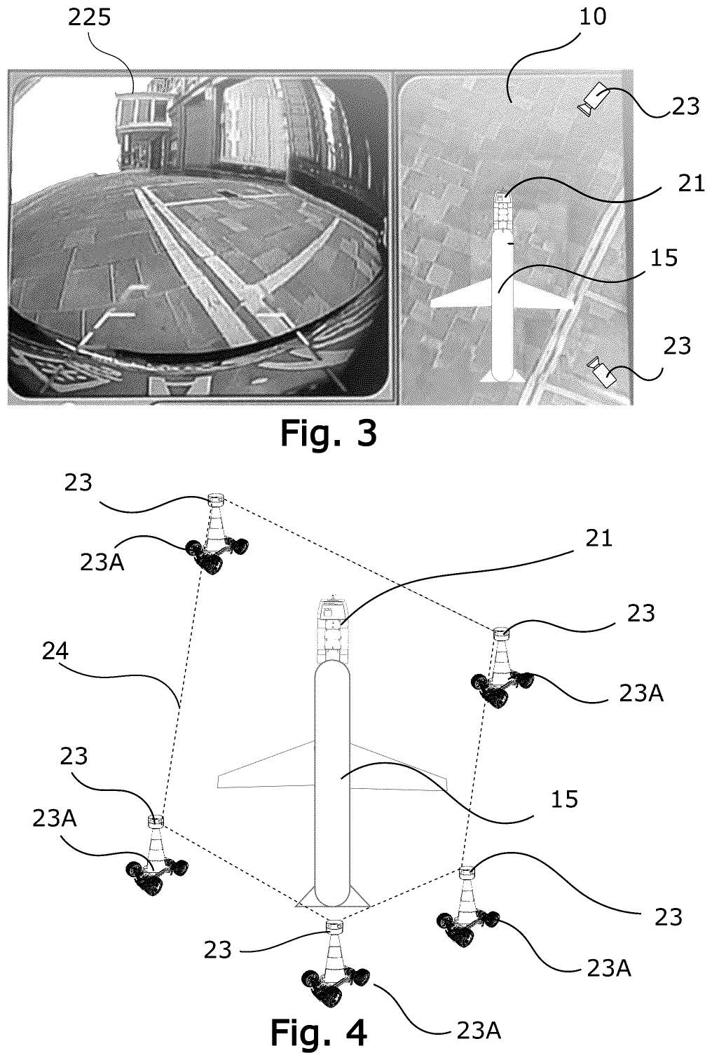

A final screen 225 allows the operator 31 to view the information supplied by the first sensors regarding the elements 11A, 11B, 11C likely to be encountered by the aircraft and/or the tow-tractor 21 during the operation of towing the aircraft 15 using the tow-tractor 21. In the present embodiment, the display supplied by this final screen 225 comprises, as shown in FIG. 3, a 360° view reconstructed from the images supplied by the first sensors 23, in this instance digital optical cameras operating in wavelengths of the visible part of the spectrum. Of course, such visualization of the information supplied by the first sensors 23 is merely one exemplary embodiment of the invention.

It will be noted that, in this same example, it is possible for the control device 22 further to be configured to identify the elements 11A, 11B, 11C likely to be encountered by the aircraft 15 and/or the tow-tractor 21 and draw attention to them, for example by highlighting them brighter and possibly indicating their distance relative to the aircraft 15 and/or to the tow-tractor 21.

In a variant which has not been illustrated, since the first detectors are designed to supply information regarding the location of said elements 11A, 11B, 11C, the control device may be designed to supply a view of the zone around the tow-tractor of the aircraft featuring the location, or even an area occupied by said elements 11A, 11B, 11C likely to be encountered by the aircraft 15 and/or the tow-tractor 21. To do this, the first sensors 23 may thus also be sensors able to determine the position, for example by triangulation, of radiofrequency tags affixed to said elements 11A, 11B, 11C.

The control device 22 further comprises a processing unit, not illustrated, such as one or more computers, one or more dedicated electronic units or a hybrid combination including one or more computers interfaced with one or more dedicated electronic units. In the present embodiment, the processing unit is connected to the human/machine interface, this interface being controlled by the control interface 221 and controlling the display on the screens 222, 223, 225. Aside from the wireless connection for allowing the control of the tow-tractor 21 and the collection of the information supplied by the second sensor or sensors, the processing unit is also connected to the first sensors so as to be able to collect the information supplied by the first sensors 23. Advantageously, the processing unit is also in communication with a control tower, not illustrated, of the airport 1 so as to be informed of the requirements in terms of towing.

It will of course be noted that while, in the present embodiment, the control device 22 is configured to allow the tow-tractor 21 to be controlled remotely by the operator 31, it is also conceivable, without departing from the scope of the invention, for the control device to be configured to control one or more tow-tractors without the intervention of an operator on the basis of towing operation demands transmitted by the control tower. Likewise, other hybrid solutions are perfectly compatible with the invention, the operator 31 then participating in only certain phases of the towing operation, such as the coupling of the aircraft 15 or to supply general instructions without supplying real-time commands as envisioned in the context of the present embodiment. Likewise, the control device 22 may also offer several operating configurations with the possibility of switching between the various control possibilities mentioned hereinabove, this switchover being able to be performed either according to a choice made when installing the towing system (notably according to the type of first and second sensors with which the hardstanding 10 and the tow-tractor or tractors 21 are equipped) or on a case by case basis according to the complexity of the towing operation.

As shown in FIG. 1, the first sensors 23 are fitted to the hardstanding 10 and are arranged therein in such a way as to be able to monitor at least one zone thereof in which the towing operation is likely to be performed.

Thus it may be seen in FIG. 1 that the hardstanding 10 in this present embodiment comprises four first sensors 23 arranged at the four corners of the hardstanding 10 in order to cover the entirety of the surface thereof. In the context of this embodiment, the first sensors 23 are sensors able to supply an image of at least part of the hardstanding 10. The first sensors 23 are more specifically optical cameras operating in the wavelengths of the visible part of the spectrum.

According to the invention, as a variant, the first sensor or sensors 23 may each be selected from among: an optical camera operating in the visible or the infrared part of the spectrum and an imager of the LIDAR type. Other types of first sensors 23 are also conceivable, in addition to or as a replacement for first sensors of the imaging type, such as detection devices, for example of telemeter type, able to detect the elements likely to be encountered by the aircraft and/or the tow-tractor during the operation of towing the aircraft using the tow-tractor 21.

It will be noted that the elements 11A, 11B, 11C likely to be encountered by the aircraft 15 and/or the tow-tractor 21 are, in the context of the present document, any type of element that can be found on a hardstanding 10 such as, for example and nonlimitingly, goods or luggage 11A intended to be loaded into an aircraft or which have been unloaded from an aircraft, a vehicle 11B moving around or parked on the hardstanding 10, a mobile or nonmobile structural element 11C of the hardstanding 10 or even a ramp agent.

Such a towing system may be installed in an airport using a method for installing a system for towing aircraft 15 that comprises the following steps:
supplying the tow-tractor or tractors 21 (or more specifically in the present embodiment the tow-tractors 21) configured to be operated remotely by means of a wireless connection and suitable for towing the aircraft 15,
installing the control device or devices 22 connected to the tow-tractor or tractors 21 using the wireless connection, the control device or devices being able to control said tow-tractor or tractors 21, and
equipping the hardstanding 10 with the first sensor 23 (or in the context of this embodiment, the first sensors 23 able to supply information about elements 11A, 11B, 11C likely to be encountered by the aircraft 15 and/or the tow-tractor 21 during the operation of towing the aircraft 15 using the tow-tractor 21.

Likewise, such a towing system also makes it possible to implement a method for towing aircraft 15, comprising the following steps:
identifying the aircraft 15 to be towed on the hardstanding equipped with the first sensor or sensors 23 able to supply information about elements likely to be encountered by the aircraft 15 and/or a tow-tractor 21 during the operation of towing the aircraft 15,
identifying the tow-tractor 21 configured to be operated remotely by means of a wireless connection and able to tow the aircraft 15,
remotely controlling the tow-tractor 21 identified to tow the aircraft using a control device connected to the tow-tractor 21 using the wireless connection, the control device collecting the information supplied by the first sensor or sensors 23 and exploiting it or them in controlling the tow-tractor 21.

As already discussed in connection with FIG. 2, the steps of identifying the aircraft and the tow-tractor 21 may be performed by the operator using fleet management software such as the XOPS™ software marketed by the RESONATE™ company

It will be noted that, more specifically, the control device 22, or more generally the control devices, may perfectly well be integrated into the airport operating operations by following protocols set in place by the control tower. In this possibility, the towing system may allow implementation of a method for managing aircraft 15 accommodated in the airport 1 and more specifically on the hardstandings 10 of the aircraft. Such a management method comprises the following steps:
identifying the tow-tractor or tractors 21 available, taking into consideration their location and their operational status, such as, for example, their battery or tank level,
defining, in accordance with a protocol imposed by the control tower and the configuration of the hardstandings, the successive towing operations to be performed by the tow-tractors 21,
controlling, in accordance with the present invention, the tow-tractor or tractors 21 using the control device or devices 22 for controlling towing operations in accordance with the definition decided upon.

FIG. 4 illustrates an aircraft towing system according to a second embodiment of the invention in which the first sensors 23 are mounted on dedicated autonomous vehicles 23A. An aircraft towing system according to this second embodiment differs from a towing system according to the first embodiment in that the first sensors are fitted to a respective dedicated mobile vehicle 23A and are therefore not arranged fixedly on the hardstanding.

In the context of this second embodiment, the mobile vehicles 23A equipped with the first sensors are configured to accompany the aircraft 15 and the tow-tractor 21 throughout the towing operation so as to cover the entirety of the zone around the aircraft and define an immaterial barrier 24 around same.

According to one possibility of the invention, the dedicated mobile vehicles are preferably autonomous and may thus, for example, be programmed to position themselves with respect to a reference element of the aircraft 15 or with respect to the tow-tractor 21. In a variant, the mobile vehicles may be controlled by the control device or the tow-tractor 21 so that they move at the same time as the tow-tractor 21 so that the first sensors 23 together cover a given zone with reference to the tow-tractor 21. Of course, in this variant, this given zone may be adapted according to the size of the aircraft 15. In this way, the mobile vehicles 23A together define, as shown in FIG. 4, an immaterial barrier 24 bounding this given zone in which the arrival of any type of element 11A, 11B, 11C likely to be encountered by the aircraft 15 and/or the tow-tractor 21 will be detected.

A towing system according to this second embodiment of the invention offers the advantage of making it easier to equip the airport 1 because such a system does not require the hardstanding 10 in which the towing is to take place to have been pre-equipped with the first sensors 23 since the tow-tractor 21 can be accompanied by the dedicated mobile vehicles when it arrives to perform the towing operation.

It will also be noted that, as a variant of the first or second embodiment described hereinabove and has already been discussed, the first sensors may be fitted to airport vehicles, such as other tractors. In the context of this variant, the first sensors may thus be sensors with which these vehicles are already equipped notably in the context of rendering these autonomous. Like the second embodiment, this variant of the first and second embodiment also offers the advantage of making it easier to equip the airport 1 since such a system does not require the hardstanding 10 in which the towing is to be performed to have been pre-equipped.

Of course, in the context of the invention, the towing system may also be a hybrid of the first, second and this last variant of the invention without departing from the scope of the invention, it being possible for example for certain first sensors to be fitted to the hardstanding and for other first sensors to be fitted to other airport vehicles.

1. Aircraft towing system for an airport having at least one towing zone in which an aircraft is likely to be towed, the towing system comprising:
at least one tow-tractor configured to be operated remotely by means of a wireless connection and suitable for towing the aircraft,
at least one control device intended to be connected to the tow-tractor using the wireless connection and able to control said tow-tractor, and
at least one first sensor intended to be positioned in the towing zone, this or these first sensors being independent of the tow-tractor and being able to supply information about elements likely to be encountered by the aircraft and/or the tow-tractor during the operation of towing the aircraft using the tow-tractor,
the control device being further configured to collect the information supplied by the at least one first sensor and exploit it in controlling the tow-tractor to tow the aircraft.

2. The aircraft towing system according to claim 1, wherein the at least one first sensor is a sensor able to supply an image of at least part of the towing zone.

3. The aircraft towing system according to claim 2, wherein said at least one first sensor is selected from: an optical camera working in the visible or in the infrared and an imager of the LIDAR type.

4. The aircraft towing system according to claim 1, wherein the control device has a human/machine interface so as to allow said tow-tractor to be controlled by an operator from said control device.

5. The aircraft towing system according to claim 2, wherein the control device has a human/machine interface so as to allow said tow-tractor to be controlled by an operator from said control device and wherein the control device comprises a display system able to supply a display including, at least in part, the image or images supplied by the at least one first sensor.

6. The aircraft towing system according to claim 5, comprising a plurality of first sensors intended to equip the towing zone and wherein the control device is configured to combine the images supplied by the first sensors in order to supply a display of the elements likely to be encountered by the aircraft and/or the tow-tractor on the towing zone during the towing operation.

7. The aircraft towing system according to claim 1, wherein the at least one first sensor is intended to be installed fixedly in the towing zone.

8. The aircraft towing system according to claim 1, wherein the, or at least one, first sensor is fitted to a mobile vehicle.

9. The aircraft towing system according to claim 8, wherein said mobile vehicle is selected from an airport vehicle and a dedicated, advantageously autonomous, mobile vehicle.

10. The aircraft towing system according to claim 1, wherein the at least one tow-tractor comprises at least one second sensor able to detect an obstacle lying in its path and wherein the control device is further configured to collect the information supplied by the at least one second sensor and exploit it in controlling a tow-tractor to tow the aircraft.

11. The aircraft towing system according to claim 1, wherein the control device is able to control the tow-tractor autonomously on the basis of at least the information supplied by the first sensor or sensors.

12. Airport equipped with an aircraft towing system according to claim 1.

13. Method for installing a system for towing aircraft according to claim 1 in an airport, the airport having at least one towing zone in which an aircraft is likely to be towed, the installation method comprising the following steps:
supplying at least one tow-tractor configured to be operated remotely by means of a wireless connection and suitable for towing the aircraft,
installing at least one control device connected to the tow-tractor using the wireless connection and able to control said tow-tractor, and
arranging, in the towing zone, at least one first sensor able to supply information about elements likely to be encountered by the aircraft and/or the tow-tractor during the operation of towing the aircraft using the tow-tractor, the each first sensor being independent of the tow-tractor,
wherein the control device is further configured to collect the information supplied by the at least one first sensor and exploit it in controlling the tow-tractor to tow the aircraft.

14. The method according to claim 13, wherein equipping the towing zone with at least one first sensor is achieved by deploying at least one mobile vehicle having said at least one first sensor, the mobile vehicle being selected from an airport vehicle and a dedicated autonomous mobile vehicle.

15. Method for towing aircraft comprising the following steps:
identifying the aircraft that is to be towed in a towing zone equipped with at least one first sensor able to supply information about elements likely to be encountered by the aircraft and/or a tow-tractor during an operation of towing the aircraft,
identifying a tow-tractor configured to be operated remotely by means of a wireless connection and suitable for towing the aircraft,
remotely controlling the tow-tractor identified for towing the aircraft from a control device connected to the tow-tractor using the wireless connection, the control device collecting the information supplied by the at least one first sensor and exploiting it or them in controlling the tow-tractor, the first sensor being arranged in the towing zone and being suitable for supplying information about elements likely to be encountered by the aircraft and/or the tow-tractor during the operation of towing the aircraft using the tow-tractor, the or each first sensor being independent of the tow-tractor.
